(19) United States
(12) Patent Application Publication
(10) Pub. No.: US 2026/0017734 A1
(43) Pub. Date: Jan. 15, 2026

(54) NEIGHBORHOOD HOME SCORES

(71) Applicant: STATE FARM MUTUAL AUTOMOBILE INSURANCE COMPANY, Bloomington, IL (US)

(72) Inventors: Jason Goldfarb, Bloomington, IL (US); Richa Shrestha, Plano, TX (US); Sean Hickey, Albuquerque, NM (US); Bryan Nussbaum, Edwardsville, IL (US); Laura A. Uphoff, Normal, IL (US)

(21) Appl. No.: 19/027,093

(22) Filed: Jan. 17, 2025

Related U.S. Application Data
(60) Provisional application No. 63/669,506, filed on Jul. 10, 2024.
(60) Provisional application No. 63/696,456, filed on Sep. 19, 2024.

(51) Int. Cl. G06Q 50/16

(52) U.S. Cl. CPC G06Q 50/16

(57) ABSTRACT

The following relates generally to generating and/or displaying home scores. In some embodiments, one or more processors: receive an overall home score for a subject property; receive a plurality of overall home scores for respective properties of a plurality of properties, wherein the plurality of properties does not include the subject property; receive a geographic filtering parameter; filter the plurality of overall home scores based upon the geographic filtering parameter; and display, on a display: (i) an average or median of the filtered plurality of overall home scores, (ii) a comparison of the overall home score for the subject property to the average or median of the filtered plurality of overall home scores, and/or (iii) respective overall home scores of the plurality of overall home scores.

### CROSS REFERENCE TO RELATED APPLICATIONS

This application claims the benefit of: (i) U.S. Provisional Application No. 63/696,456, entitled “Neighborhood Home Scores” (filed Sep. 19, 2024), and (ii) U.S. Provisional Application No. 63/669,506, entitled “Neighborhood Home Scores” (filed Jul. 10, 2024), the entirety of each of which is incorporated by reference herein.

### FIELD

The present disclosure generally relates to generating and/or displaying home scores, and, more particularly to, viewing relationships between home scores for a subject property and home scores of other homes.

### BACKGROUND

Determining and presenting a home score (e.g., a score rating a home, etc.) may be important to an insurance company. For example, when an insurance customer's home has a high home score, the insurance company may offer the customer a discount on homeowners insurance. However, present systems for determining and/or displaying home scores and/or subscores may have certain drawbacks.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

The present embodiments may relate to, inter alia, generating and/or displaying home scores and/or subscores. For example, a customer (or prospective customer) of an insurance company may be presented (e.g., on a display of a smartphone) with an overall home score, a plurality of home subscores, home scores for other homes, and/or comparisons between her home and the other homes. The plurality of subscores may include a safety subscore, a structural subscore, a plumbing subscore, an appliances subscore, a heating, ventilation, and air conditioning (HVAC) subscore, etc.

In one aspect, a computer-implemented method for improved generation of home scores and/or improved comparison of the home scores may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) receiving, via one or more processors, an overall home score for a subject property; (2) receiving, via the one or more processors, a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores; (3) receiving, via the one or more processors, a geographic filtering parameter; (4) filtering, via the one or more processors, the plurality of overall home scores based upon the geographic filtering parameter; and/or (5) displaying, via the one or more processors, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The method may include additional, fewer, or alternate actions, including those discussed elsewhere herein.

In another aspect, a computer device configured for improved generation of home scores and/or improved comparison of the home scores may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) receive an overall home score for a subject property; (2) receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores; (3) receive a geographic filtering parameter; (4) filter the plurality of overall home scores based upon the geographic filtering parameter; and/or (5) display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The computer device may include additional, less, or alternate functionality, including that discussed elsewhere herein.

In yet another aspect, a computer system configured for improved generation of home scores and/or improved comparison of the home scores may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive an overall home score for a subject property; (2) receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores; (3) receive a geographic filtering parameter; (4) filter the plurality of overall home scores based upon the geographic filtering parameter; and/or (5) display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A depicts an exemplary home score system, according to one embodiment.

FIG. 1B depicts an exemplary screen displaying an overall home score and subscores.

FIG. 1C depicts an exemplary screen displaying an overall home score and subscores including an appliances subscore rather than an HVAC subscore.

FIG. 2 illustrates a flow diagram representing an exemplary computer-implemented method or implementation for improved generation of home scores and/or improved comparison of the home scores.

FIG. 3 shows an exemplary table indicating information of an exemplary fire protection attribute.

FIG. 4 is a block diagram of an exemplary machine learning modeling method for training and evaluating a ML algorithm, in accordance with various embodiments.

FIG. 5 depicts a flow diagram representing an exemplary computer-implemented method or implementation for improved generation of home scores and/or improved comparison of the home scores.

FIG. 6 depicts an exemplary screen in which the user has drawn an exemplary line defining the geographic filtering parameter.

FIG. 7 depicts an exemplary screen allowing a user to enter filtering parameters.

FIG. 8 depicts an exemplary screen comparing the user's plumbing subscore to the average plumbing subscore for homes with a particular zip code.

FIG. 9 depicts an exemplary screen showing respective home scores of a plurality of properties.

FIG. 10 depicts an exemplary screen allowing a user to indicate completion of one or more insights.

FIG. 11 depicts an exemplary computer-implemented method or implementation for a second user to view home scores

### DETAILED DESCRIPTION

The present embodiments relate to, inter alia, generating and/or comparing home scores. Advantageously, an insurance company may provide an insurance customer with a discount on, for example, homeowners insurance based upon a high home score.

In some examples, an overall home score is generated based upon one or more subscores, such as (i) a safety subscore, (ii) a structural subscore, (iii) a plumbing subscore, (iv) an appliances subscore, and/or (v) a heating, ventilation, and air conditioning (HVAC) subscore. In some implementations, there is no HVAC subscore. In some such implementations, the appliances subscore includes an HVAC grade (rather than the system including a separate HVAC subscore).

Further advantageously, a user may compare her overall home score or any of her subscores home scores of other homes. Still further advantageously, an additional user, such as a prospective homebuyer, may, with the homeowner's permission, view the overall home score and/or any of the subscores.

### Exemplary System

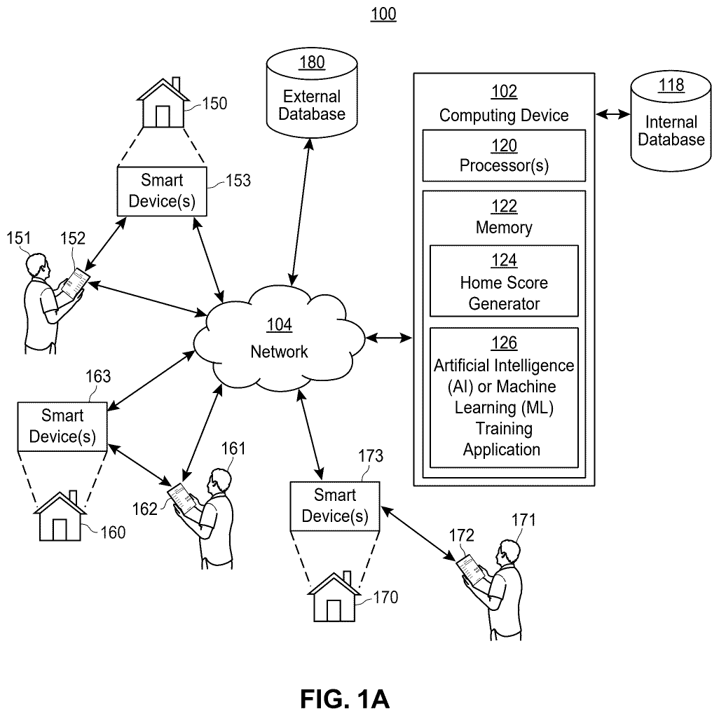

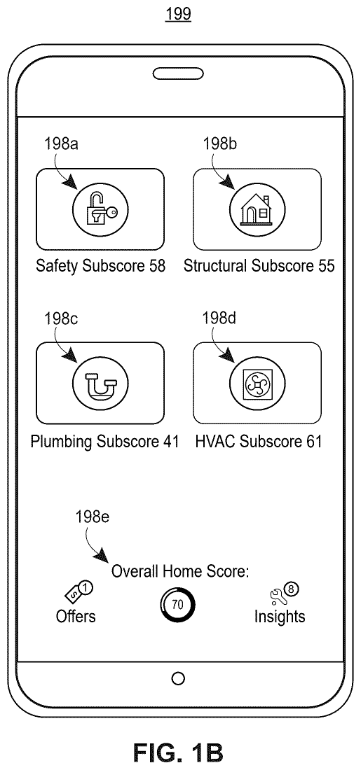

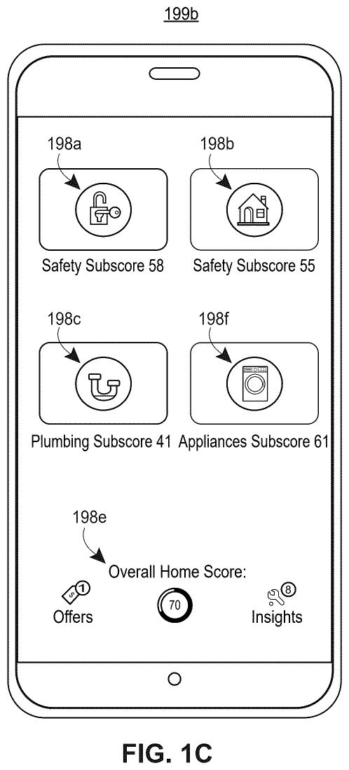

To this end, FIG. 1A illustrates an exemplary computer system 100 for generating and/or comparing home scores in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as home score generator 124, and/or artificial intelligence (AI) or machine learning (ML) training application 126.

An insurance company that owns the computing device 102 may provide insurance, such as homeowners or renters insurance, to the user 151. As such, in some situations, it may be useful for the insurance company to provide discounts on insurance to reward the user for well maintaining their home 150. To this end, it is useful for the insurance company to generate home score(s) for the home 150. Moreover, the user 151 may advantageously view his home score(s) to track how well he is maintaining his home and/or compare his home 150 to other homes, such as homes 160, 170.

To this end, the home score generator 124 may generate home score(s). The generation of the home score(s) will be described in further detail elsewhere herein. But, by way of brief overview, in some embodiments, the score generator 124 may generate an overall home score based upon a: (i) safety subscore, (ii) structural subscore, (iii) plumbing subscore, (iv) appliances subscore, and/or (v) HVAC subscore.

In some examples, there is a maximum overall home score and/or subscore(s) (e.g., maximum(s) of 10, 100, 1,000, 2,000, 5,000, 10,000, etc.). However, in other examples, there is no maximum overall home score and/or subscore(s).

In some embodiments, the home score(s) are not generated based upon AI and/or ML. However, in other embodiments, the home score(s) are generated based upon AI and/or ML. In some such embodiments, the AI or ML training application 126 may train model(s) and/or algorithm(s) for the home score generator 124 to use for home score generation. For example, as will be described elsewhere herein, the AI or ML training application 126 may route historical data into the model(s) and/or algorithm(s) for training.

In some embodiments, the home score(s) are generated, at least in part, from sensor data from the home 150, 160, 170. Such sensor data may come from smart device(s) 153, 163, 173.

Any of the users 151, 161, 171 may use their respective user devices 152, 162, 172 to view the home score(s) (e.g., via a display of the user device 152, 162, 172). The user devices 152, 162, 172 may be any suitable device, such as a computer, a mobile device, a smartphone, a laptop, a phablet, a chatbot or voice bot, etc. The device may include one or more display devices, one or more processors, one or more memories, etc.

FIG. 1B depicts an exemplary screen 199 (e.g., on a display of any of the user devices 152, 162, 172). Exemplary screen 199 depicts: safety subscore 198a, structural subscore 198b, plumbing subscore 198c, HVAC subscore 198d, and overall home score 198e.

FIG. 1C depicts an exemplary screen 199b (e.g., on a display of any of the user devices 152, 162, 172) including an appliances subscore rather than an HVAC subscore. Exemplary screen 199 depicts: safety subscore 198a, structural subscore 198b, plumbing subscore 198c, appliances subscore 198f, and overall home score 198e.

The exemplary system 100 may also include external database 180 and internal database 118. Examples of the data stored by the external database 180 and/or internal database 118 include: historical information used to train AI and/or ML models and/or algorithms, insurance claim information, home score(s) of home(s), etc.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of users, user devices, homes, smart devices, computing devices, databases, etc.).

### Exemplary Method for Home Score Generation Using an Exemplary Non-AI or ML Technique

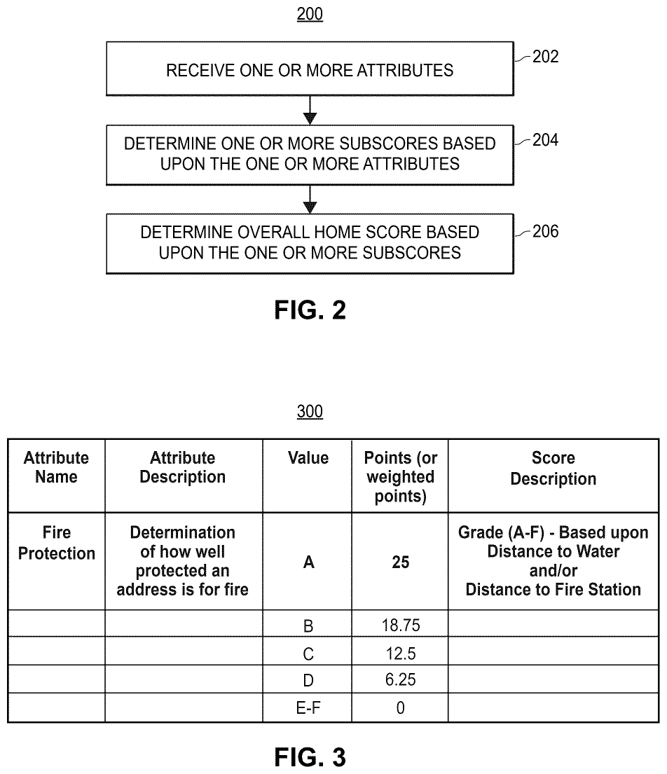

FIG. 2 illustrates a flow diagram representing an exemplary computer-implemented method or implementation 200 for improved generation of home scores and/or improved comparison of the home scores. The exemplary computer-implemented method or implementation 200 may be implemented by a computing environment 100, for example, including the computing device 102, any of the user devices 152, 162, 172, and/or any suitable device including those discussed elsewhere herein, such as one or more local or remote processors, transceivers, memory units, sensors, mobile devices, unmanned aerial vehicles (e.g., drones), etc. In some embodiments, the exemplary computer-implemented method or implementation 200 may be implemented by the home score generator 124.

The exemplary computer-implemented method or implementation 200 may begin at block 202 when the one or more processors 120 receive one or more attributes. Examples of the one or more attributes include (i) safety attribute(s), (ii) structural attribute(s), (iii) plumbing attribute(s), (iv) appliances attribute(s), and/or (v) HVAC attribute(s).

In some examples, the safety attribute(s) include fire protection attribute(s), weather hazard attribute(s), crime attribute(s), and/or other hazard attributes. Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores. In some examples, the grades are assigned by human experts. The assigned grades and/or categorical values may then be stored in a database (e.g., external database 180 and/or internal database 118), and/or sent directly to any other component in FIG. 1A.

By way of exemplary illustration, FIG. 3 shows an exemplary table 300 indicating information of an exemplary fire protection attribute. The attribute may have a name, which, in the illustrated example, is a fire protection attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points. In some embodiments, the fire protection attribute additionally or alternatively includes a grade based upon a distance from a property to water and/or a distance from the property to a fire station. The grade based upon a distance from a property to water and/or a distance from the property to a fire station may be assigned points similarly to the example of FIG. 3. In some examples, the grade is assigned to the home by a human knowledgeable with respect to homes and/or fire safety.

In some examples, the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, a freezing weather grade, and/or a convection storm grade.

In some examples, the crime attributes include a burglary grade based upon a burglary likelihood, and/or a motor vehicle theft grade based upon a motor vehicle theft likelihood.

In some examples, the other hazard attributes include a grade based upon other hazards, such as the presence of an uncovered pool, a pool without a fence, radon, gas, a trampoline, etc.

In some examples, the structural attributes include a structural grade, and/or a home age.

In some examples, the plumbing attributes include a plumbing grade, and/or a date of a most recent plumbing inspection.

In some examples, the appliances attributes include an energy grade (e.g., a grade rating how energy efficient the property 150 is), an appliances maintenance grade, HVAC attributes, and/or an age of an HVAC unit. The energy grade may be a rating based upon one or more appliances of the property 150 and/or based upon an overall energy use of the property 150. The appliances maintenance grade may be a rating based upon, for example, types of appliances, dates of when maintenance was performed on appliances, types of maintenance performed on the appliances, etc. In some examples, the appliances maintenance grade may include individual grades of respective appliances that are summed, averaged, etc. For example, the appliances maintenance grade may include a smart washing machine maintenance grade averaged with a smart dryer maintenance grade.

In some examples, the HVAC attributes include a HVAC grade, and/or an age of an HVAC unit. In some examples, the HVAC unit comprises a furnace, a heat pump, a gas or electric water heater, an evaporative cooler, and/or an air conditioning (AC) condenser.

Moreover, it should be appreciated that any of the grades mentioned above may be assigned points similarly to the example of FIG. 3.

Returning now to FIG. 2, at block 204, the one or more processors 120 may determine one or more of the subscores based upon the attribute(s). In some examples, the subscores are determined based upon points assigned to the attribute. For instance, with respect to the example of FIG. 3, if the only safety attribute is the fire protection attribute and the home has been assigned a grade of “C,” the safety subscore may be determined to be 12.5. In other examples, attributes may be summed, averaged, etc., to determine the respective subscores.

Furthermore, attributes and/or grades may be weighted. For example, if the weather hazard attribute includes an earthquake grade and a wind grade, the wind grade may be weighted more than the earthquake grade in determining the weather hazard subscore.

In some embodiments, when values are missing (e.g., NaN, etc.), they may be filled in with a neutral value. For instance, with respect to the example of FIG. 3, if any of the values corresponding to attributes with a grade (A-F) are missing, they may be filled in with a value of C.

In some embodiments, the subscores may be further modified by sensor data (e.g., from any of the smart devices 153, 163, 173, etc.). For example, data received from a water flow sensor may increase a plumbing subscore (e.g., confirming that the water flow sensor is operating properly based upon the sensor data may increase the plumbing subscore). In another example, data from an airflow sensor may increase an HVAC subscore (e.g., confirming that the airflow sensor is operating properly based upon the sensor data may increase the HVAC subscore).

In some embodiments, extra points may be given to any of the subscores based upon a user 151 returning to the app. For example, if the user 151 has not logged into the app for a predetermined period of time (e.g., a week, a month, a year, etc.), any of the subscores may be increased.

At block 206, the overall home score is determined based upon the subscores. For example, any or all of the (i) safety subscore, (ii) structural subscore, (iii) plumbing subscore, (iv) appliances subscore, and/or (v) HVAC subscore may be averaged or summed to determine the overall home score. In examples where only one subscore is available or has been calculated, the overall home score may be determined to be the subscore that is available.

In some embodiments, extra points may be given to the overall subscore based upon the user 151 returning to the app. For example, if the user 151 has not logged into the app for a predetermined period of time (e.g., a week, a month, a year, etc.), the overall home score may be increased.

Exemplary Method for Home Score Generation using an Exemplary AI or ML Technique

Broadly speaking, AI and/or ML algorithm(s) and/or model(s) may be used to determine any of the overall home score and/or the home subscores. Although the following discussion refers to an ML algorithm (or ML model), it should be appreciated that it applies equally to ML and/or AI algorithms and/or models.

In some embodiments, individual machine learning algorithms are used to determine the subscores, and then the subscores are aggregated together (e.g., by averaging, taking a weighted average, summing, etc.) to determine the overall home score. To this end, in some examples: the safety subscore is calculated via a safety subscore machine learning algorithm; the structural subscore is calculated via a structural subscore machine learning algorithm; the plumbing subscore is calculated via a plumbing subscore machine learning algorithm; the appliances subscore is calculated via an appliances subscore machine learning algorithm; and/or the HVAC subscore is calculated via a HVAC subscore learning algorithm.

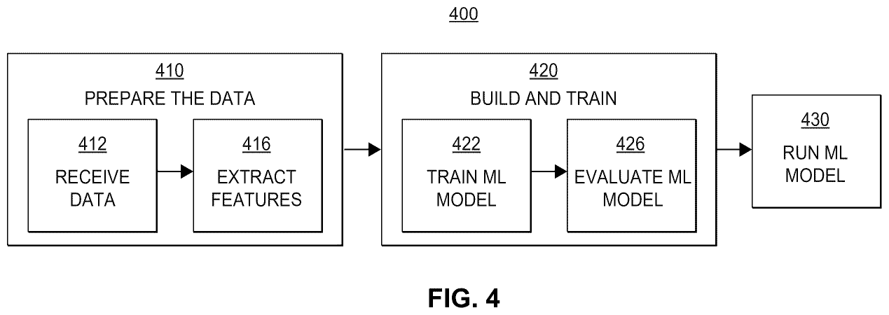

FIG. 4 is a block diagram of an exemplary machine learning modeling method 400 for training and evaluating a ML algorithm (e.g., an overall home score ML algorithm, a safety subscore ML algorithm, a structural subscore ML algorithm, a plumbing subscore ML algorithm, an appliances subscore ML algorithm, and/or a HVAC ML algorithm, etc.) (e.g., implemented by the AI or ML training application 126), in accordance with various embodiments. In some embodiments, the model “learns” an algorithm capable of performing the desired function, such as determining any of the overall home score, the safety subscore, the structural subscore, the plumbing subscore, the appliances subscore, and/or the HVAC subscore. It should be understood that the principles of FIG. 4 may apply to any machine learning algorithm discussed herein.

Although the following discussion refers to the blocks of FIG. 4 as being performed by the one or more processors 120, it should be appreciated that the blocks of FIG. 4 may be performed by any suitable component or combinations of components (e.g., the one or more processors of the user device 152, 162, 172, etc.).

At a high level, the machine learning modeling method 400 includes a block 410 to prepare the data, a block 420 to build and train the model, and a block 430 to run the model.

Block 410 may include sub-blocks 412 and 416. At block 412, the one or more processors 120 may receive (e.g., from the external database 180, the internal database 118, etc.) the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the scores that the ML algorithm is trained to determine (e.g., the dependent variable of the safety subscore ML algorithm is the safety subscore); and the independent variables are used to determine the dependent variables (e.g., independent variables to the plumbing subscore ML algorithm are historical plumbing grades, and historical dates of most recent plumbing inspections, etc.). Put another way, the independent variables may have an impact on the dependent variables; and the ML algorithms may be trained to find this impact. Therefore, when using a trained ML algorithm to determine a score, information of the home corresponding to the historical information that the ML was trained on may be routed into the ML algorithm to determine the score/subscore.

More specifically, for the historical information used to train the safety subscore machine learning algorithm, examples of the historical information include historical: (i) independent variables comprising (a) historical fire protection attributes, (b) historical weather hazard attributes, (c) historical crime attributes, and/or (d) other hazard attributes; and/or (ii) dependent variables comprising historical safety subscores.

For the historical information used to train the structural machine learning algorithm, examples of the historical information include historical: (i) independent variables including: (a) historical structural grades, and/or (b) historical home ages, and/or (ii) dependent variables comprising historical structural subscores.

For the historical information used to train the plumbing subscore machine learning algorithm, examples of the historical information include historical: (i) independent variables including: (a) historical plumbing grades, and/or (b) historical dates of most recent plumbing inspections, and/or (ii) dependent variables comprising historical plumbing subscores.

For the historical information used to train the appliances subscore machine learning algorithm examples of the historical information include historical: (i) independent variables including (a) historical energy grades, (b) historical appliances maintenance grades, and/or (c) historical heating, ventilation, and air conditioning (HVAC) attributes, and/or (ii) dependent variables comprising historical appliances subscores.

For the historical information used to train the HVAC subscore machine learning algorithm, examples of the historical information include historical: (i) independent variables including: (a) historical HVAC grades, and/or (b) historical ages of HVAC units, and/or (ii) dependent variables comprising historical HVAC subscores.

Block 420 may include sub-blocks 422 and 426. At block 422, the ML model is trained (e.g. based upon the data received from block 410). In some embodiments where associated information is included in the historical information, the ML model “learns” an algorithm capable of calculating or predicting the target feature values (e.g., determining home score(s), etc.) given the predictor feature values.

At block 426, the one or more processors 120 may evaluate the machine learning model, and determine whether or not the machine learning model is ready for deployment.

Further regarding block 426, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

In some embodiments, ML algorithms are used to determine the subscores, and then the subscores are averaged or summed to determine the overall home score.

In some embodiments, ML algorithms are used to determine the subscores, and then the overall home score is determined by taking a weighted average of the subscores. The weights may be determined by any suitable technique. For example, the weights may be based upon geographic region of the home, time of year, climate data, weather data, etc. In one working example, in a geographic region known for wildfires, during the wildfire season, the safety subscore may be given a greater weight than during the non-wildfire season.

Advantageously, using separate machine learning algorithms to determine individual subscores, and then determining the overall home score based upon the subscores improves accuracy of the overall home score determination, thereby improving technical functioning.

Moreover, it should be appreciated that the ML algorithm(s) may be any kind of ML algorithms (e.g., neural networks, convolutional neural networks, deep learning algorithms, etc.).

Exemplary Method for Improved Generation of Home Scores and/or Improved Comparison of the Home Score(s)

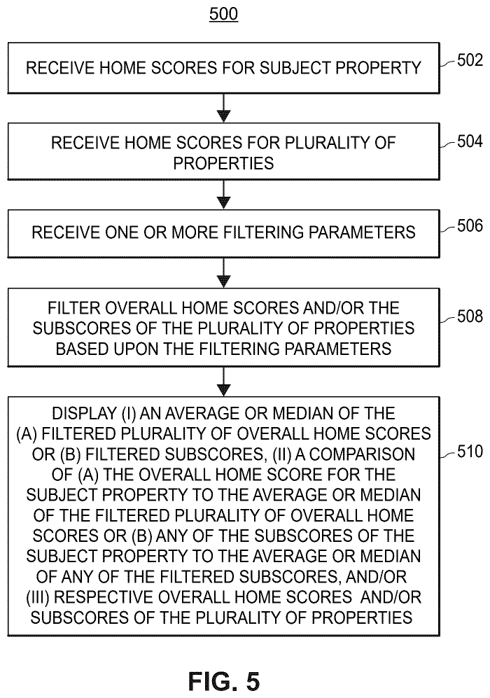

FIG. 5 illustrates a flow diagram representing an exemplary computer-implemented method or implementation 500 for improved generation of home scores and/or improved comparison of the home scores. The exemplary method 500 may be implemented by a computing environment 100, for example, including the computing device 102, any of the user devices 152, 162, 172, and/or any suitable device including those discussed elsewhere herein, such as one or more local or remote processors, transceivers, memory units, sensors, mobile devices, unmanned aerial vehicles (e.g., drones), etc.

The exemplary computer-implemented method or implementation 500 may begin at block 502 when the one or more processors 120 receive or generate a home score (e.g., an overall home score and/or any of the subscores discussed herein) for a subject property (e.g., home 150, etc.). The home score may be or have been generated in accordance with the techniques described herein (e.g., using one or both of a non-ML and/or ML technique, e.g., such as described above with respect to FIGS. 2-4, etc.).

Furthermore, at block 502 the home score may be updated and/or generated based upon the user 151 completing insights (e.g., recommendations for home projects to improve her home score, etc.). For example, if a user 151 replaces her smoke detector battery, her safety subscore may increase by 1 point, etc.

Examples of the insights include: replacing a smoke detector battery; installing a support beam; replacing at least one pipe; replacing an air filter; and/or installing a water sensor.

In some examples, any of all of the insights may be emergency preparedness insights. For instance, an emergency preparedness may help a user 151 prepare for a weather event (e.g., a storm, hurricane, hailstorm, snowstorm, etc.), or other emergency (e.g., wildfire, earthquake, etc.). In some such examples, the insight is presented to the user 151 further based upon a season. For example, during winter, an insight to winterize pipes may be presented. Additionally or alternatively, insights may be presented in response to prediction of an event. For example, in response to a prediction that a storm will occur, an insight(s) to install stronger windows, and/or repair a wall and/or roof may be presented.

In some examples, users are given extra points (e.g., either to the overall home score or any of the subscores) for completing an insight completed by another user (e.g., a neighbor of the user 151, someone who lives within a predetermined distance of the user 151, someone who lives in the same zip code as the user 151, etc.), thus gamifying the process. In some such examples, a temporal restraint may be applied. For instance, the extra points may be given only if the user 151 completes the insight within a predetermined time period (e.g., a week, a month, a year, etc.) of the other user completing the insight.

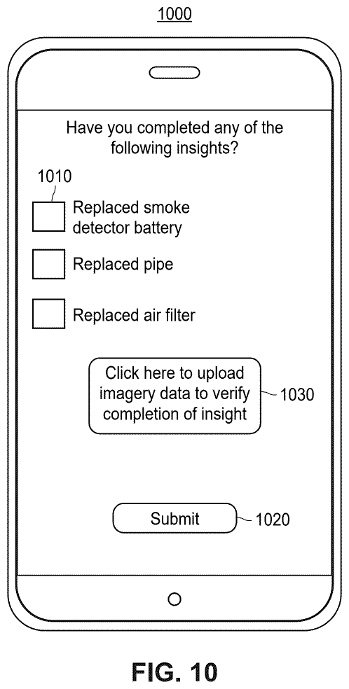

FIG. 10 depicts an exemplary screen allowing a user 151 to indicate completion of one or more insights. For example, the user 151 may indicate that she has replaced a smoke detector battery by marking the checkbox 1010, and pressing submit button 1020. In some examples, the system may also indicate how much each insight will increase the overall home score and/or subscores by. In one example, next to an insight of “replaced pipe,” “+1 point to your plumbing subscore” may be displayed.

In some embodiments, the user 151 must verify that she has completed the insight by uploading imagery data (e.g., image data and/or video data). To this end, button 1030 allows the user 151 to upload such imagery data. Additionally or alternatively, the user 151 may be prompted to enter the imagery data upon pressing the submit button 1020.

In some embodiments, the overall home score or any of the subscores may be reduced if the user 153 does not complete the insight within a predetermined completion time period (e.g., HVAC subscore reduced if air filter is not replaced upon expiration of a predetermined completion time period, etc.).

At block 504, the one or more processors 120 receive or generate a home score (e.g., an overall home score and/or any of the subscores discussed herein) for a plurality of properties (e.g., homes 160, 170, etc.). The home score may be or have been generated in accordance with the techniques described herein (e.g., using one or both of a non-ML and/or ML technique, etc.). The plurality of properties may include any number of properties (e.g., 10 properties, 100 properties, 1000 properties, etc.).

At block 506, the one or more processors 120 receive one or more filtering parameters. Examples of the filtering parameters include geographic filtering parameters, subscore filtering parameters, and/or home score filtering parameters. Advantageously, as will be seen, the filtering parameter(s) allow a user to view particular pieces of data, especially for comparison to her own scores. For example, a geographic filter may allow a user to view other home scores for homes within a particular geographic range. In another example, a subscore filtering parameter may allow a user to view home with particular subscores of a particular type (e.g., view only structural subscores, etc.) and/or in a particular range (e.g., subscores with a value of 50-60, etc.). In another example, a home score filtering parameter may allow a user to compare her score to scores for homes in a particular age range.

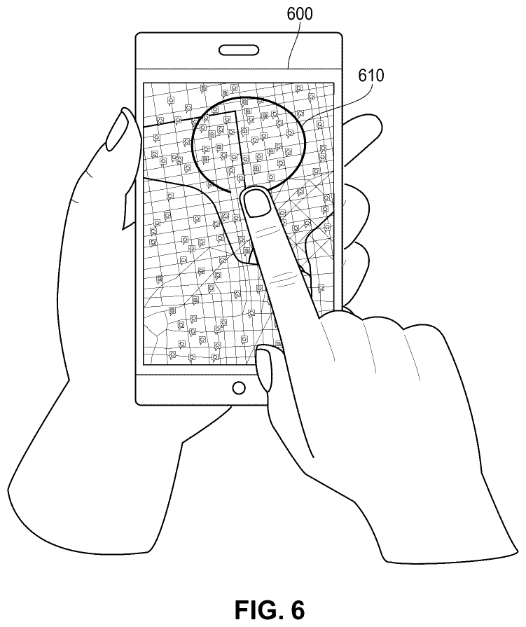

Examples of the geographic filtering parameter include: (i) a distance filter (e.g., a Euclidean distance, such as specifying a number of miles, etc.); (ii) a zip code filter; and/or (iii) a jurisdiction filter (e.g., a city, county, village, state, or any other jurisdiction). Additionally or alternatively, a map may be displayed (e.g., on a display of user device 152), which allows the user 151 to draw in free form on the map to create the geographic filtering parameter. FIG. 6 depicts an exemplary screen 600 in which the user 151 has drawn an exemplary line 610 defining the geographic filtering parameter.

In some embodiments, if the user 151 does not enter a geographic filter, a default geographic filter is set (e.g., all homes within 1 mile of the subject property 150).

Examples of the subscore filtering parameter include a safety subscore filtering parameter, a structural subscore filtering parameter, a plumbing subscore filtering parameter, a HVAC filtering parameter, and/or a subscore range filtering parameter.

Examples of the home score filtering parameter include: (i) a home age parameter, (ii) a square footage parameter, (iii) a number of bathrooms parameter, (iv) a number of bedrooms parameter, (v) a school district score parameter, and/or (vi) an estimated home value parameter.

In some examples, any of the parameters may be a discrete value (e.g., 1 mile; zip code 12345; etc.). In some examples, the parameters may be a range (e.g., 1-3 miles; 2-4 bathrooms; safety subscore of 25-50; etc.).

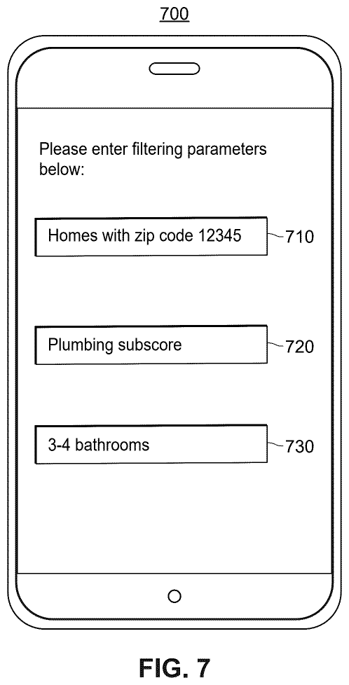

FIG. 7 depicts an exemplary screen 700 allowing a user 151 to enter filtering parameters. In the illustrated example, the user 151 has entered: a geographic filtering parameter of zip code 12345; a subscore filtering parameter of a plumbing subscore; and a home score parameter of 3-4 bathrooms.

At block 508, the one or more processors 120 may filter the overall home scores and/or subscores from the plurality of properties based upon the one or more filtering parameters. For example, if there is a filter parameter including a home age parameter of a home age of 50-60 years, the filtering at block 508 may remove homes that are not in that home age range.

At block 510, the one or more processors 120 may display (e.g., on a display of any of the user devices 152, 162, 172): (i) an average or median of the (a) filtered plurality of overall home scores or (b) filtered subscores, (ii) a comparison of (a) the overall home score for the subject property to the average or median of the filtered plurality of overall home scores or (b) any of the subscores of the subject property to the average or median of any of the filtered subscores, and/or (iii) respective overall home scores and/or subscores of the plurality of properties.

Additionally or alternatively, at block 510, an alert may be displayed. Examples of the alert include: (i) an alert that the overall home score or any of the subscores of the subject property has fallen below a level in relation to the average or median of the filtered plurality of overall home scores or subscores, and/or (ii) an alert that the overall home score or any of the subscores of the subject property will fall below a level in relation to the average or median of the filtered plurality of overall home scores or subscores if an insight is not completed within a predetermined time period.

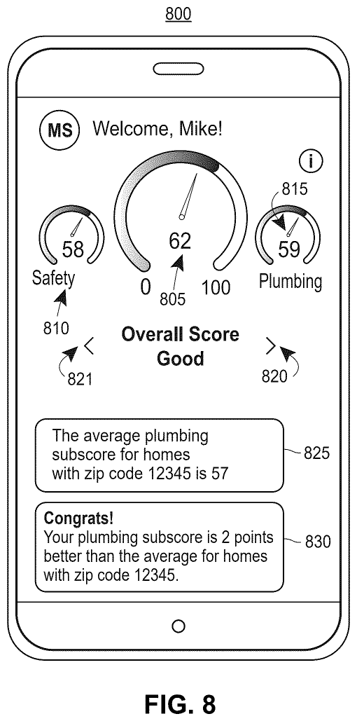

FIG. 8 depicts an exemplary screen 800 (e.g., on a display of any of the user devices 152, 162, 172). In the example of FIG. 8, the filtering parameters from FIG. 7 have been applied. Exemplary screen 800 depicts: (i) average plumbing subscore 830 for zip code 12345; and (ii) comparison 825 of the user's plumbing subscore to the average plumbing subscore for zip code 12345. The illustrated example further depicts the user's overall home score 805, safety subscore 810, and plumbing subscore 815. Arrows 820, 821 allow the user 151 to toggle between subscores (e.g., pressing arrow 821 may show the structural subscore, etc.).

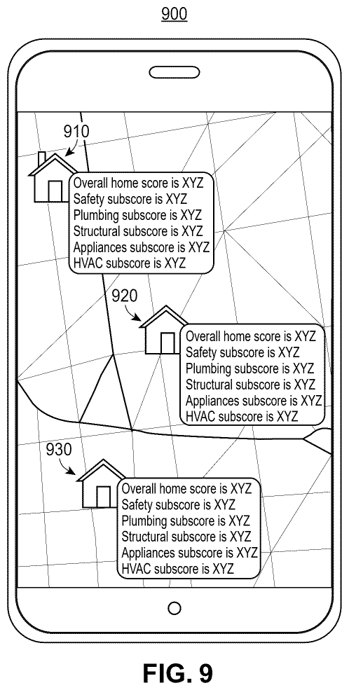

FIG. 9 depicts an exemplary screen 900 (e.g., on a display of any of the user devices 152, 162, 172) showing respective home scores of a plurality of properties. In the illustrated example, the plurality of properties includes homes 910, 920, 930.

Advantageously, in some embodiments, a second user may be able to view the home scores of the subject property. For example, the second user may be a prospective buyer of the subject property, and therefore wish to view the home scores. However, in some embodiments, the user 151 (e.g., the owner of the subject property 150) must first give permission.

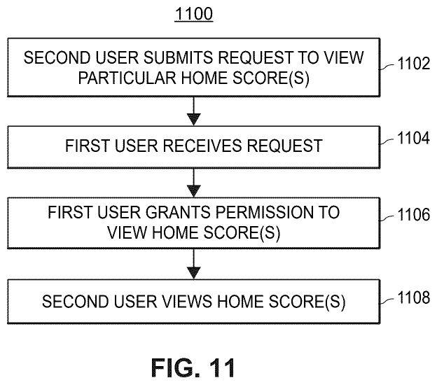

FIG. 11 depicts an exemplary computer-implemented method or implementation 1110 for a second user 161 to view home scores. At block 1102, the second user 161 may request permission to view home scores of the subject property 150 (e.g., the plumbing subscore and the structural subscore).

At block 1104, first user 151 receives the request, and views the request (e.g., on a display of the user device 152).

At block 1106, the first user 151 grants permission for the second user 161 to view the home scores. The request may be granted in whole or in part (e.g., user 151 grants permission to view the plumbing subscore, but not the structural subscore).

At block 1108, the second user 161 is allowed to view the home scores (e.g., on a display of user device 162) based upon the granted permission. Advantageously, requiring permission from the first user improves computer security.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for improved generation of home scores and/or improved comparison of the home scores may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) receiving, via one or more processors, an overall home score for a subject property; (2) receiving, via the one or more processors, a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, (iv) respective appliances subscores, and/or (v) respective heating, ventilation, and air conditioning (HVAC) subscores; (3) receiving, via the one or more processors, a geographic filtering parameter; (4) filtering, via the one or more processors, the plurality of overall home scores based upon the geographic filtering parameter; and/or (5) displaying, via the one or more processors, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The method may include additional, fewer, or alternate actions, including those discussed elsewhere herein.

In some embodiments, the geographic filtering parameter includes: (i) a distance filter; (ii) a zip code filter; and/or (iii) a jurisdiction filter.

In some embodiments, the computer-implemented method further includes: displaying, via the one or more processors, on the display, a map; receiving, via the one or more processors, user input on the map; and/or setting, via the one or more processors, the geographic filtering parameter according to the user input.

In some embodiments, the overall home score for the subject property is determined based upon one more subscores including: (i) a safety subscore, (ii) a structural subscore, (iii) a plumbing subscore, and/or (iv) a heating, ventilation, and air conditioning (HVAC) subscore.

In some embodiments, the computer-implemented method further includes: receiving, via the one or more processors, the respective subscores; receiving, via the one or more processors, a subscore filtering parameter; filtering, via the one or more processors, the respective subscores based upon the subscore filtering parameter; and/or displaying, via the one or more processors, on a display: (i) an average or median of the filtered respective subscores, (ii) a comparison of a subscore for the subject property to the average or median of the filtered respective subscores, and/or (iii) at least one subscore of the filtered respective subscores.

In some embodiments, the computer-implemented method further includes: receiving, via the one or more processors, a home score filtering parameter including: (i) a home age parameter, (ii) a square footage parameter, (iii) a number of bathrooms parameter, (iv) a number of bedrooms parameter, (v) a school district score parameter, and/or (vi) an estimated home value parameter; filtering, via the one or more processors, the respective home scores of the plurality of home scores based upon the home score filtering parameter; and/or displaying, via the one or more processors, on a display, the filtered respective home scores of the plurality of home scores.

In some embodiments, the respective subscores include the respective safety subscores, and/or the method further includes: determining, via the one or more processors, the respective safety subscores based upon: fire protection attributes, weather hazard attributes, and/or crime attributes.

In some embodiments, the fire protection attributes include a grade based upon a distance from a property to water and/or a distance from the property to a fire station; the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade; and/or the crime attributes include (i) a burglary grade based upon a burglary likelihood, and/or (ii) a motor vehicle theft grade based upon a motor vehicle theft likelihood.

In some embodiments, the respective subscores include the respective structural subscores, and/or the method further includes: determining, via the one or more processors, the respective structural subscores based upon: a structural grade, and/or a home age.

In some embodiments, the respective subscores include the respective plumbing subscores, and/or the method further includes: determining, via the one or more processors, the respective plumbing subscores based upon: a plumbing grade, and/or a date of a most recent plumbing inspection.

In some embodiments, the respective subscores include the respective appliances subscores, and/or the method further includes: determining, via the one or more processors, the respective appliances subscores based upon an energy grade, an appliances maintenance grade, and/or a heating, ventilation, and air conditioning (HVAC) attribute.

In some embodiments, the respective subscores include the respective HVAC subscores, and/or the method further includes: determining, via the one or more processors, the respective HVAC subscores based upon: a HVAC grade, and/or an age of an HVAC unit.

In some embodiments, the subject property corresponds to a first user, and/or the method further includes: receiving, via the one or more processors, a request from a second user to view the overall home score for the subject property; in response to receiving the request, requesting, via the one or more processors, permission from the first user to allow the second user to view the overall home score for the subject property; receiving, via the one or more processors, from the first user, the permission; and/or in response to receiving the permission, allowing, via the one or more processors, the second user to view the overall home score for the subject property.

In some embodiments, the computer-implemented method further includes: presenting, via the one or more processors, one or more insights to a user corresponding to the subject property; receiving, via the one or more processors, from the user, an indication that at least one insight of the one or more insights has been completed; and/or in response to receiving the indication, updating, via the one or more processors, the overall home score for the subject property.

In some embodiments, the one or more insights include: replacing a smoke detector battery; installing a support beam; replacing at least one pipe; replacing an air filter; and/or installing a water sensor.

In some embodiments, the computer-implemented method further includes: presenting, via the one or more processors, one or more insights to a user corresponding to the subject property; receiving, via the one or more processors, from the user, an indication that at least one insight of the one or more insights has been completed; in response to receiving the indication, requesting, via the one or more processors, from the user, imagery data associated with the at least one insight; receiving, via the one or more processors, the imagery data from the user; verifying, via the one or more processors, that the at least one insight has been completed based upon the imagery data; and/or in response to the verification, updating, via the one or more processors, the overall home score for the subject property.

In some embodiments, the respective subscores include the respective safety subscores, and/or the method further includes: training a safety subscore machine learning algorithm by inputting historical information into the safety subscore machine learning algorithm, the historical information including: (i) independent variables comprising (a) historical fire protection attributes, (b) historical weather hazard attributes, (c) historical crime attributes, and/or (d) other hazard attributes; and/or (ii) dependent variables comprising historical safety subscores; and/or determining the respective safety subscores by routing information of properties into the safety subscore machine learning algorithm.

In some embodiments, the respective subscores include the respective structural subscores, and/or the method further includes: training a structural subscore machine learning algorithm by inputting historical information into the structural subscore machine learning algorithm, the historical information comprising: (i) independent variables including: (a) historical structural grades, and/or (b) historical home ages, and/or (ii) dependent variables comprising historical structural subscores; and/or determining the respective structural subscores by routing information of properties into the structural subscore machine learning algorithm.

In some embodiments, the respective subscores include the respective plumbing subscores, and/or the method further includes: training a plumbing subscore machine learning algorithm by inputting historical information into the plumbing subscore machine learning algorithm, the historical information comprising: (i) independent variables including: (a) historical plumbing grades, and/or (b) historical dates of a most recent plumbing inspections, and/or (ii) dependent variables comprising historical plumbing subscores; and/or determining the respective plumbing subscores by routing information of properties into the plumbing subscore machine learning algorithm.

In some embodiments, the respective subscores include the respective appliances subscores, and/or the method further includes: training an appliances subscore machine learning algorithm by inputting historical information into the appliances subscore machine learning algorithm, the historical information comprising: (i) independent variables including (a) historical energy grades, (b) historical appliances maintenance grades, and/or (c) historical heating, ventilation, and air conditioning (HVAC) attributes, and/or (ii) dependent variables comprising historical appliances subscores; and/or determining the respective appliances subscores by routing information of properties into the appliances subscore machine learning algorithm.

In some embodiments, the respective subscores include the respective HVAC subscores, and/or the method further includes: training a HVAC subscore machine learning algorithm by inputting historical information into the HVAC subscore machine learning algorithm, the historical information comprising: (i) independent variables including: (a) historical HVAC grades, and/or (b) historical ages of HVAC units, and/or (ii) dependent variables comprising historical HVAC subscores; and/or determining the respective HVAC subscores by routing information of properties into the HVAC subscore machine learning algorithm.

In another aspect, a computer device configured for improved generation of home scores and/or improved comparison of the home scores may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) receive an overall home score for a subject property; (2) receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, (iv) respective appliances subscores, and/or (v) respective heating, ventilation, and air conditioning (HVAC) subscores; (3) receive a geographic filtering parameter; (4) filter the plurality of overall home scores based upon the geographic filtering parameter; and/or (5) display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The computer device may include additional, less, or alternate functionality, including that discussed elsewhere herein.

In some embodiments, the one or more processors are further configured to: display, on the display, a map; receive user input on the map; and/or set the geographic filtering parameter according to the user input.

In yet another aspect, a computer system configured for improved generation of home scores and/or improved comparison of the home scores may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive an overall home score for a subject property; (2) receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, (iv) respective appliances subscores, and/or (v) respective heating, ventilation, and air conditioning (HVAC) subscores; (3) receive a geographic filtering parameter; (4) filter the plurality of overall home scores based upon the geographic filtering parameter; and/or (5) display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores. The computer system may include additional, less, or alternate functionality, including that discussed elsewhere herein.

In some embodiments, the one or more non-transitory memories having stored thereon computer-executable instructions that, when executed by the one or more processors, cause the one or more processors to: display, on the display, a map; receive user input on the map; and/or set the geographic filtering parameter according to the user input.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for improved generation of home scores and/or improved comparison of the home scores, the method comprising:
receiving, via one or more processors, an overall home score for a subject property;
receiving, via the one or more processors, a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores;
receiving, via the one or more processors, a geographic filtering parameter;
filtering, via the one or more processors, the plurality of overall home scores based upon the geographic filtering parameter; and
displaying, via the one or more processors, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores.

2. The computer-implemented method of claim 1, wherein the geographic filtering parameter includes: (i) a distance filter; (ii) a zip code filter; and/or (iii) a jurisdiction filter.

3. The computer-implemented method of claim 1, further including:
displaying, via the one or more processors, on the display, a map;
receiving, via the one or more processors, user input on the map; and
setting, via the one or more processors, the geographic filtering parameter according to the user input.

4. The computer-implemented method of claim 1, further including:
receiving, via the one or more processors, the respective subscores;
receiving, via the one or more processors, a subscore filtering parameter;
filtering, via the one or more processors, the respective subscores based upon the subscore filtering parameter; and
displaying, via the one or more processors, on a display: (i) an average or median of the filtered respective subscores, (ii) a comparison of a subscore for the subject property to the average or median of the filtered respective subscores, and/or (iii) at least one subscore of the filtered respective subscores.

5. The computer-implemented method of claim 1, further including:
receiving, via the one or more processors, a home score filtering parameter including: (i) a home age parameter, (ii) a square footage parameter, (iii) a number of bathrooms parameter, (iv) a number of bedrooms parameter, (v) a school district score parameter, and/or (vi) an estimated home value parameter;
filtering, via the one or more processors, the respective home scores of the plurality of home scores based upon the home score filtering parameter; and
displaying, via the one or more processors, on a display, the filtered respective home scores of the plurality of home scores.

6. The computer-implemented method of claim 1, wherein the respective subscores include the respective safety subscores, and the method further includes:
determining, via the one or more processors, the respective safety subscores based upon fire protection attributes, weather hazard attributes, and/or crime attributes.

7. The computer-implemented method of claim 6, wherein:
the fire protection attributes include a grade based upon a distance from a property to water and/or a distance from the property to a fire station;
the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade; and
the crime attributes include (i) a burglary grade based upon a burglary likelihood, and/or (ii) a motor vehicle theft grade based upon a motor vehicle theft likelihood.

8. The computer-implemented method of claim 1, wherein the respective subscores include the respective structural subscores, and the method further includes:
determining, via the one or more processors, the respective structural subscores based upon: a structural grade, and/or a home age.

9. The computer-implemented method of claim 1, wherein the respective subscores include the respective plumbing subscores, and the method further includes:
determining, via the one or more processors, the respective plumbing subscores based upon: a plumbing grade, and/or a date of a most recent plumbing inspection.

10. The computer-implemented method of claim 1, wherein the respective subscores include the respective appliances subscores, and the method further includes:
determining, via the one or more processors, the respective appliances subscores based upon an energy grade, an appliances maintenance grade, and/or a heating, ventilation, and air conditioning (HVAC) attribute.

11. The computer-implemented method of claim 1, wherein the subject property corresponds to a first user, and the method further includes:
receiving, via the one or more processors, a request from a second user to view the overall home score for the subject property;
in response to receiving the request, requesting, via the one or more processors, permission from the first user to allow the second user to view the overall home score for the subject property;
receiving, via the one or more processors, from the first user, the permission; and
in response to receiving the permission, allowing, via the one or more processors, the second user to view the overall home score for the subject property.

12. The computer-implemented method of claim 1, further including:
presenting, via the one or more processors, one or more insights to a user corresponding to the subject property;
receiving, via the one or more processors, from the user, an indication that at least one insight of the one or more insights has been completed; and
in response to receiving the indication, updating, via the one or more processors, the overall home score for the subject property.

13. The computer-implemented method of claim 12, wherein the one or more insights include:
replacing a smoke detector battery;
installing a support beam;
replacing at least one pipe;
replacing an air filter; and/or
installing a water sensor.

14. The computer-implemented method of claim 1, further including:
presenting, via the one or more processors, one or more insights to a user corresponding to the subject property;
receiving, via the one or more processors, from the user, an indication that at least one insight of the one or more insights has been completed;
in response to receiving the indication, requesting, via the one or more processors, from the user, imagery data associated with the at least one insight;
receiving, via the one or more processors, the imagery data from the user;
verifying, via the one or more processors, that the at least one insight has been completed based upon the imagery data; and
in response to the verification, updating, via the one or more processors, the overall home score for the subject property.

15. The computer-implemented method of claim 1, wherein the respective subscores include the respective safety subscores, and the method further includes:
training a safety subscore machine learning algorithm by inputting historical information into the safety subscore machine learning algorithm, the historical information including: (i) independent variables comprising (a) historical fire protection attributes, (b) historical weather hazard attributes, and/or (c) historical crime attributes, and/or (ii) dependent variables comprising historical safety subscores; and
determining the respective safety subscores by routing information of properties into the safety subscore machine learning algorithm.

16. The computer-implemented method of claim 1, wherein the respective subscores include the respective structural subscores, and the method further includes:
training a structural subscore machine learning algorithm by inputting historical information into the structural subscore machine learning algorithm, the historical information comprising: (i) independent variables including: (a) historical structural grades, and/or (b) historical home ages, and/or (ii) dependent variables comprising historical structural subscores; and
determining the respective structural subscores by routing information of properties into the structural subscore machine learning algorithm.

17. The computer-implemented method of claim 1, wherein the respective subscores include the respective plumbing subscores, and the method further includes:
training a plumbing subscore machine learning algorithm by inputting historical information into the plumbing subscore machine learning algorithm, the historical information comprising: (i) independent variables including: (a) historical plumbing grades, and/or (b) historical dates of a most recent plumbing inspections, and/or (ii) dependent variables comprising historical plumbing subscores; and
determining the respective plumbing subscores by routing information of properties into the plumbing subscore machine learning algorithm.

18. The computer-implemented method of claim 1, wherein the respective subscores include the respective appliances subscores, and the method further includes:
training an appliances subscore machine learning algorithm by inputting historical information into the appliances subscore machine learning algorithm, the historical information comprising: (i) independent variables including (a) historical energy grades, (b) historical appliances maintenance grades, and/or (c) historical heating, ventilation, and air conditioning (HVAC) attributes, and/or (ii) dependent variables comprising historical appliances subscores; and
determining the respective appliances subscores by routing information of properties into the appliances subscore machine learning algorithm.

19. A computer device for improved generation of home scores and/or improved comparison of the home scores, the computer device comprising one or more processors configured to:
receive an overall home score for a subject property;
receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores;
receive a geographic filtering parameter;
filter the plurality of overall home scores based upon the geographic filtering parameter; and
display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores.

20. A computer system for improved generation of home scores and/or improved comparison of the home scores, the computer system comprising:
one or more processors; and
one or more non-transitory memories, the one or more non-transitory memories having stored thereon computer-executable instructions that, when executed by the one or more processors, cause the one or more processors to:
receive an overall home score for a subject property;
receive a plurality of overall home scores for respective properties of a plurality of properties, wherein the plurality of properties does not include the subject property, and wherein respective overall home scores of the plurality of overall home scores are determined based upon respective subscores including: (i) respective safety subscores, (ii) respective structural subscores, (iii) respective plumbing subscores, and/or (iv) respective appliances subscores;
receive a geographic filtering parameter;
filter the plurality of overall home scores based upon the geographic filtering parameter; and
display, on a display, (i) an average or median of the filtered plurality of overall home scores, (ii) a comparison of the overall home score for the subject property to the average or median of the filtered plurality of overall home scores, and/or (iii) respective overall home scores of the plurality of overall home scores.
